(19) United States
(12) Patent Application Publication
(10) Pub. No.: US 2015/0061186 A1
(43) Pub. Date: Mar. 5, 2015

(54) Promotional Item with Moldable Dough and Packaging

(71) Applicant: American Covers, Inc., Draper, UT (US)

(72) Inventor: Bryce Haymond, Pleasant Groove, UT (US)

(21) Appl. No.: 14/012,729

(22) Filed: Aug. 28, 2013

(51) Int. Cl. B29C 33/42; B29C 43/00; B29C 43/02

(52) U.S. Cl. CPC B29C 33/424; B29C 43/021; B29C 43/003
USPC 264/299; 425/318

(57) ABSTRACT

A promotional item has a moldable dough with a mold insert embedded therein disposed in a container. The moldable dough and the mold insert have a three-dimensional indicia associated with or representing a business and/or a product.

### RELATED APPLICATION(S)

This is related to U.S. patent application Ser. No. 13/838,021, filed Mar. 15, 2013; which claims priority to U.S. Provisional Patent Application Ser. No. 61/694,912, filed Aug. 30, 2012; which are hereby incorporated herein by reference.

### BACKGROUND

1. Field of the Invention

The present invention relates generally to promotional items and/or moldable dough.

2. Related Art

Promotional items are typically inexpensive items of functional or whimsical value that carry a product or business name and that can be given away by companies to get their brand in front of viewers or potential users. An example of a functional promotional item is a pen with a business name and contact information thereon. An example of a whimsical promotional item is a puzzle or game also with a business or product name thereon. One challenge is to develop an item that is inexpensive enough that it can be given away in bulk. Another challenge is to develop an item that has perceived value or that can capture interest in order to motivate the user to keep and/or use the item, and thus maintain the brand in view of and/or in use by the user.

### SUMMARY OF THE INVENTION

It has been recognized that it would be advantageous to develop a promotional item that is able to repeatedly place a logo (or other indicia of a business or product) in front of a user for an extended period of time, and/or repeatedly capture the user's attention.

The invention provides a promotional device with a container comprising a window portion that is at least translucent. A moldable dough is disposed in the container and is pliable. A mold insert is disposed in the container and has a protrusion, an indentation, or both, formed therein and forming a three-dimensional indicia indicative of or representing a business, a product, or both, and defining an interior negative mold. The interior negative mold is embedded in the dough to form an exterior positive impression of the mold in the dough, and thus a three-dimensional indicia indicative of or representing the business, product, or both, in the dough. The mold insert, the moldable dough, or both are visible through the window portion of the container.

In addition, the invention provides a promotional device with a container comprising an opening with a removable lid covering the opening in the container, and with the lid and the container forming a substantially air-tight compartment. The lid is at least translucent. A moldable dough is disposed in the container and is pliable. A mold insert is disposed in the container and comprises a sheet having a protrusion, an indentation, or both, formed therein and forming a three-dimensional indicia indicative of or representing a business, a product, or both, and defining an interior negative mold on an interior side, and an exterior positive representation opposite of the interior negative mold on an opposite exterior side. The plastic sheet comprises a single layer with a substantially constant thickness, with an indentation on the interior side of the plastic sheet corresponding to a protrusion on the opposite exterior side. The interior negative mold is embedded in the dough to form an exterior positive impression of the mold in the dough, and thus a three-dimensional indicia indicative of or representing the business, product, or both, in the dough. A release coating is on the interior negative mold of the mold insert. The release coating comprising a silicon oil. The sheet is at least translucent with the dough being visible therethrough. The exterior positive impression of the mold in the dough, and the three-dimensional indicia indicative of or representing the business, product, or both, in the dough, being visible through the mold insert and the lid.

Furthermore, the invention provides a method for making a promotional device, comprising obtaining a plurality of precursors. Each precursor includes: a container having a cavity therein and an opening therein to the cavity, and a lid removably coupled to the container and covering the cavity and closing the opening, the container and the lid forming a substantially air-tight compartment in the cavity; and a moldable dough disposed in the cavity of the container. The method comprises embossing or debossing a plurality of mold inserts. Each mold insert includes: a protrusion, an indentation, or both, formed in the mold insert and forming a three-dimensional indicia indicative of or representing a business, a product, or both, and defining an interior negative mold thereof on an interior of the mold insert. The method comprises removing the lid from each of the plurality of precursors; pressing each mold insert into the dough to impart the interior negative mold of the mold insert into the dough to form an exterior positive impression of the mold in the dough and thus a three-dimensional indicia indicative of or representing the business, product, or both, in the dough; and replacing the lid on each of the plurality of precursors.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a top view of a promotional device in accordance with an embodiment of the present invention having a container with a lid and a mold insert and a moldable dough having a protrusion, an indentation, or both formed therein, and forming a three-dimensional indicia indicative of or representing a business, a product, or both, such as a logo;

FIG. 2 is a side view of the promotional device of FIG. 1;

FIG. 3 is a bottom view of the promotional device of FIG. 1;

FIG. 4 is an exploded side view of the promotional device of FIG. 1 showing the moldable dough and the mold insert in the container;

FIG. 5 is a top view of the mold insert of the promotional device of FIG. 1 showing a sheet having a protrusion, an indentation, or both, formed therein and forming a three-dimensional indicia indicative of or representing a business, a product, or both, and defining an interior negative mold on an interior side, and an exterior positive representation opposite of the interior negative mold on an opposite exterior side;

FIG. 6 is a top view of the moldable dough of the promotional device of FIG. 1 showing an exterior positive impression of the mold in the dough and thus a three-dimensional indicia indicative of or representing the business, product, or both, in the dough, and showing a molded configuration in which the dough has the three-dimensional indicia therein, and removed location in which the dough is removed out of the container;

FIG. 7 is a side view of the mold insert pressed into and imbedded in the moldable dough of the promotional device of FIG. 1;

FIG. 8 is a side view of the mold insert being removed from the moldable dough of the promotional device of FIG. 1; and

FIG. 9 is a side view of the mold insert being pressed into the moldable dough of the in the container of the promotional device of FIG. 1, and showing the moldable dough in a random configuration in which the dough has a random configuration without the three-dimensional indicia.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

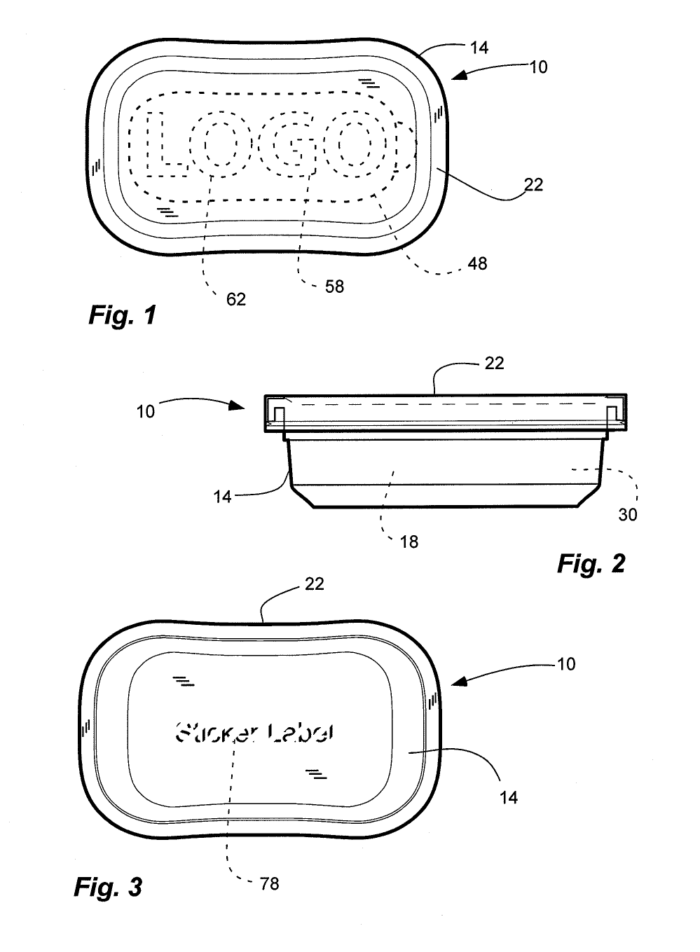

Referring to FIGS. 1-9, a promotional item or device, indicated generally at 10, in an example implementation in accordance with the invention is shown. The promotional item 10 can be provided by businesses, corporations or other organizations, with indicia indicative of or representing a business (or company or organization), a product or service, or both, such as a logo, message, slogan, etc. In addition, a plurality of precursors can be provided that can be customized to have the indicia.

The promotional item 10 includes a container 14 containing a moldable dough 18. The moldable dough 18 can be flexible, malleable and/or pliable under manual exertion (i.e. by hand without the need for tools or machines). Thus, the dough 18 can be removed from the container 14 and molded as desired by a user. The moldable dough can be any type of commercially available dough. In addition, the dough can be: any appropriate color, including brightly colored with standard, pastel or florescent colors and/or brightness. In one aspect, the color of the dough can correspond to a logo, or business or product indicia, as described below. In another aspect, the dough can include two or more separate and discrete colors, such as by including two or more separate and discrete bodies of the dough adjacent one another in the container. In another aspect, the dough can be or can contain a phosphorous material, or like substance, such as Zinc Sulfide and Strontium Aluminate, so that the dough can glow. In another aspect, the dough can have inclusions, such as small plastic novelties or logos. The inclusions can have a different consistency than the dough. In another aspect, the dough can include a scent material, different from the natural scent of the dough itself, to give a more aesthetically pleasing fragrance to the dough. In another aspect the dough can include an anti-bacterial agent. The dough can be of the type that does not flack or crumble, but that maintains coherence. In addition, the dough can be of the type that dries in air over time to a rigid or hardened form. Alternatively, the dough can remain pliable in air over time.

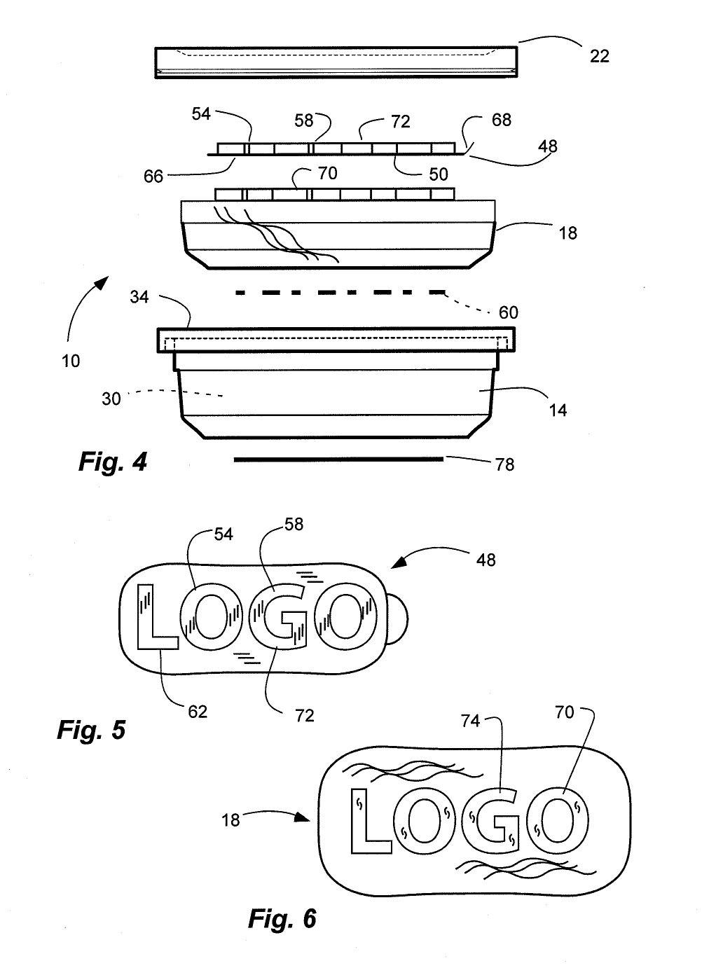

The container 14 can have a lid 22 and a cavity 30 therein with an opening 34 (FIG. 4) therein to the cavity closed and covered by the lid. The container 14 can be formed by a bowl or vessel and the lid 22. The container 14, or the lid 22 and container 14 (or bowl or vessel), can form a substantially air-tight compartment in the cavity. The moldable dough 18 is disposed in and can substantially fill the volume or cavity 30 of the container 14. In one aspect, a volume of the dough can match the volume of the container or cavity. In another aspect, a volume of the dough can be less than the volume of the container or cavity to form a gap or air space between the dough and the lid. The container can include at least a portion that is window portion that is at least translucent (i.e. translucent or transparent) so that contents of the container are visible therethrough. In one aspect, at least the lid 22 can be at least translucent. In another aspect, the entire container, including the bowl or vessel and the lid can be at least translucent. The container and lid can be formed of plastic and can be molded, such as by injection molding.

The lid 22 is removably coupled to the container 14 (or bowl or vessel) and covers the cavity 30 and closes the opening 34. The lid 22 and the container 14 (or bowl or vessel) can together form a substantially air-tight compartment in the cavity 30, and define a volume therein. In another aspect, the container, or the lid and the container, can form more than one cavity with dough in each one of the cavities. Thus, the container can have interior walls separating the cavity into multiple cavities. Similarly, the lid can have partitions that can correspond to the interior walls of the container. The dough in the different cavities can have different characteristics, such as different colors, etc. The container, and/or the lid and the container, can have various different shapes and sizes, including a shape matching or corresponding to the indicia or logo described below.

The container, or the lid and the container (or bowl or vessel), can be formed of or can include a plastic material. The container, or the lid and the container, can be formed of a single layer of plastic with a substantially constant thickness, with protrusions on one side corresponding to indentations on the other, and vise versa. The lid and the container can be formed by injection molding. A release coating can be applied to an interior surface of the lid 22 and/or the container 14 to resist the dough 18 sticking to the container or interior surfaces thereof. The release coating can be or can include a silicon oil. The lid 22 and/or the container, or at least a portion thereof, can be transparent, or at least translucent. Thus, the dough can be viewed through the container or transparent portion thereof. In another aspect, the container, and/or the lid, can be formed of wood, metal, plastic, glass, or another material, and can be opaque.

A mold insert 48 is disposed in the container 14 and embedded or pressed into the moldable dough 18. A protrusion, an indentation, or both 58, are formed in the mold insert 48, and forms a three-dimensional indicia 62 indicative of or representing a business (or company), a product, or both, such as a logo, and defines an interior negative mold 66 (FIG. 4) thereof on an interior side 50 (FIG. 4) of the mold insert 48. The interior negative mold 66 is embedded or pressed into the moldable dough 18. The logo or indicia 62 can be or can include letters, symbols, figures, pictures, logos, art, corporate messages, slogans, bi-lines, icons, etc. that are associated with or that form a representation of a business, company or organization or the like, or a product, service or the like, or both. The logo or indicia 62 can be raised in, indented into, or both, of the mold insert 48. The mold insert 48 can include or be formed of a plastic sheet. The plastic sheet can be a single layer with substantially constant thickness, with protrusions on one side corresponding to indentations on the other, and vise versa. The plastic sheet can have the protrusion, the indentation, or both forming the interior negative mold 66 on the interior side 50; and an exterior positive representation 72 opposite of the interior negative mold on the opposite exterior side 54. The indicia 62 can be embossed or raised, or debossed or lowered, in the plastic sheet. The indicia 62 can protrude from an opposite exterior side 54 (FIG. 4) of the mold insert and plastic sheet, and protrude or extend into the interior side 50. In another aspect, the indicia can be recessed or extend into the exterior side of the mold insert and plastic sheet, and protrude from the interior side. In another aspect, a protrusion, an indentation, or both, can be formed in the lid and/or the container. The protrusion and/or indentation can have a thickness, depth and/or elevation between 0.05 mm and 20 mm. The mold insert, and the three-dimensional indicia therein, can be formed by vacuum forming, or embossing or debossing. The mold insert and the plastic sheet can be at least translucent.

As discussed above, the mold insert 48 or negative mold 66 can be pressed into and embedded in (or the interior side embedded in) the dough 18 with the dough abutting to the interior negative mold 66 of the mold insert to form an exterior positive impression 70 (FIGS. 4 and 6) of the mold in the dough, and thus a three-dimensional indicia 74 (FIG. 6) indicative of or representing the a business, company or organization or the like, or a product, service or the like, or both as discussed above, in the dough 18.

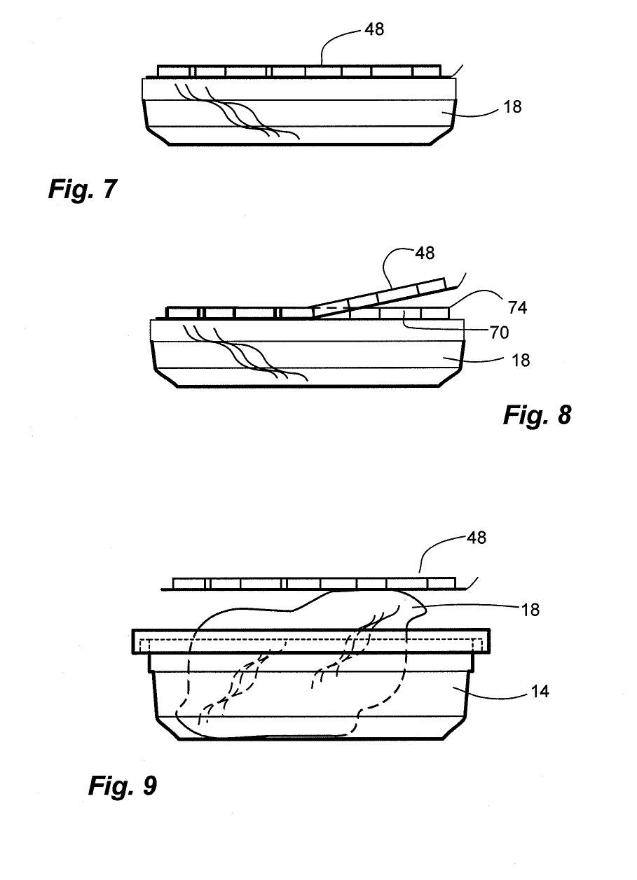

The moldable dough 18 has at least two locations, including: an enclosed location and a removed location. In the enclosed location, the dough 18 is disposed in the container 14, as shown in FIGS. 1-3. In the removed location, the dough 18 is removed out of the container 14, as shown in FIGS. 4 and 6-8. The mold insert 48 can accompany the dough 18 in the enclosed and removed location. Thus, the mold insert 48 can remain embedded in the dough 18 both in the container, as shown in FIGS. 1-3, and outside of the container, as shown in FIGS. 7 and 8. In addition, the moldable dough 18 can have at least two configurations, including: a molded configuration and a random configuration. In the molded configuration, the dough 18 has the three-dimensional indicia 74 from the interior negative mold 66 of the mold insert therein, and can have the internal shape of the cavity 30 as well, as shown in FIGS. 4 and 6. The dough 18 can have the molded configuration both in and out of the container 14, or in both the enclosed and removed locations. In the random configuration, the dough 18 has a random configuration without the three-dimensional indicia, as shown in FIG. 9. The mold insert 48 can be pressed into or embedded into the dough 18 both in and out of the container, or while the dough is in either the enclosed or removed location. The dough 18 can be removed from the container 14 with the mold insert 48 embedded in the dough 18, as shown in FIG. 7. The mold insert 48 can be removed from the dough 18 leaving the three-dimensional indicia 74 and/or exterior positive impression 70 of the mold 66 in the dough, as shown in FIG. 8. The mold insert 48 can include a tab 68 at a perimeter thereof extending away from the dough to allow a user to grasp the tab and pull or peal the mold insert 48 from the dough, as shown in FIG. 8. Providing the mold insert 48 with the three-dimensional indicia 62 encourages the user to repeatedly make impressions in the dough of the indicia representing the business, product or both.

Furthermore, the mold insert 48 can have at least two locations with respect to the container 14, including: an enclosed location and a removed location. In the enclosed location, the mold insert 48 is disposed in the container 14, as shown in FIGS. 1-3. In the removed location, the mold insert 48 is removed out of the container 14, as shown in FIGS. 4, 5 and 7-9. As stated above, the mold insert 48 can accompany the dough 18 due to the embedded nature of the mold insert, or interior side 50 or mold 66 thereof, in the dough. In addition, the mold insert 48 can have at least two locations with respect to the dough 18, including: an embedded location and a removed location. In the embedded location, the mold insert 48 is embedded in the dough 18, as shown in FIG. 7. In the removed location, the mold insert 48 is removed from the dough 18, as shown in FIG. 4. The mold insert 48 can be pressed into the dough 18, and the dough can be pressed into the container 14, as shown in FIG. 9.

The mold insert 48, and the interior negative mold 66 thereof, can be used as a tool or toy to form an exterior positive impression 70 of the mold in the dough, and thus a three-dimensional indicia 74 indicative of or representing the business, product, or both, in the dough, when the dough is inside or outside of the container, or in the enclosed or removed location. Thus, the dough does not need to be in the container in order to form the impression or indicia in the dough. Similarly, the container 14 (or lid 22) or mold insert can be used as a tool or toy to form the impression or indicia in other soft substances, such as sand, mud, clay, bread, other types of dough, or other materials that can retain their shape for an extended period of time, etc. As described above, the dough 18 can be of the type that dries in air over time to a rigid or hardened form. Thus, the impression or indicia 74 formed in the dough 18 can be allowed to dry and harden outside of the container, or in the removed location, to keep the impression or indicia formed in the dough indefinitely. The volume of the container 14 can be greater than the area of the lid 22, and the dough 18 can tend to stay in the container 14 when the lid is removed. Thus, the impression or indicia 74 formed in the dough 18 in the container 14 can be exposed to a user upon opening of the container.

As discussed above, the container 14, the lid 22 and/or the window portion thereof can be at least translucent (translucent or transparent). Thus, the mold insert 48 (or positive representation 72) and/or the dough 18 can be visible through the container 14, or the lid 22 or window portion thereof. And the three-dimensional indicia 62 of the mold insert 48 can be visible through the container 14, or the lid 22 or window portion thereof. Thus, the indicia indicative of or representing a business (or company), a product, or both, such as a logo, is presented to the user, and thus becomes a promotion. Similarly, the mold insert and/or the sheet thereof can also be at least translucent (translucent or transparent). Thus, the exterior positive impression 70 of the mold 66, and/or the three-dimensional indicia 74, in the dough 18 is visible through the mold insert 48, and the container 14, or lid 22 or window portion thereof. And the indicia indicative of or representing a business (or company), a product, or both, such as a logo, is presented to the user, and thus becomes a promotion.

In addition, the promotional item 10 can include a matching indicia, such as a sticker or label 78, carried by an exterior surface of the container 14 or the lid 22. The matching indicia can correspond to the three-dimensional indicia 62 on the mold insert. The indicia or sticker 78 can have an image or the indicia on an adhesive side of the sticker to face against the container or the lid and into the cavity so that the image or indicia is visible on the inside of the container or lid (through a transparent lid) when the dough is removed. In another aspect, the promotional item can include a matching indicia, such as a sticker or label 80 (FIG. 4) carried by an interior surface of the container 14 or the lid 22. The matching indicia can correspond to the three-dimensional indicia 62 on the mold insert. The indicia or sticker 80 can have an image or the indicia on an adhesive side of the sticker to face against the container or the lid and out of the cavity so that the image or indicia is visible on the outside of the container or lid (through the transparent container or lid).

A method for making a promotional device 10 as described above includes obtaining a plurality of precursors. The precursors can include the container 14 with the dough 18 therein, as described above, but without the mold insert. Each precursor can be similar to the promotional item described above, but without the mold insert, including: a container 14 having a lid 22 and a cavity 30 therein with an opening 34 therein to the cavity, and a lid 22 coupled to the container and covering the cavity and closing the opening, the lid and the container forming a substantially air-tight compartment in the cavity and defining a volume therein. The container 14 and the lid 22 can include a release coating applied to an interior surface thereof. A moldable dough 18 is disposed in the volume or cavity of the container.

A plurality of mold inserts 48 is embossed or debossed. Each mold insert includes: a protrusion, an indentation, or both 58, formed in the mold insert and forming a three-dimensional indicia 62 indicative of or representing a business, a product, or both, and defining an interior negative mold 66 thereof on an interior side of the mold insert. The mold inserts 48 can include a release coating applied to an interior surface thereof (or to the interior negative mold 66). The lid 22 is removed from each container 14 or precursor. Each mold insert 48 is pressed into the dough in each container or precursor to impart the interior negative mold of the mold insert into the dough to form an exterior positive impression 70 of the mold in the dough and thus a three-dimensional indicia 74 indicative of or representing the business, product, or both, in the dough. The lid is replaced on each of the precursors.

The moldable dough can be viewed through mold insert and the lid, with the at least a portion of the lid, the mold insert, or both being at least translucent.

Thus, logos or indicia 74 are molded into the dough using the mold insert. The logo can be embossed or debossed in the mold insert, causing the dough inside to deform to the shape of the logo when the mold insert is pressed into the dough. Silicone oil or release coating can be applied to the interior side of the mold insert and container. Marketing via a sticker label may also be placed on the container, as well as by a hanging or string type tag from a hole through the container.

Although the mold insert has been shown with the interior negative mold having an indentation to form the positive impression of the mold in the dough as a protrusion, it is of course understood that the interior negative mold can have a protrusion to form the positive impression in the dough as an indentation.

Although the container has been shown with a lid and a separate container (or bowl or vessel), the container can be formed by a single lid and a single container formed from a single sheet or web of plastic with a hinge (such as a living hinge) therebetween.

Although the mold insert, or the sheet thereof, have been described as being formed of a single layer with substantially a single thickness such that the three-dimensional indicia 74 in the dough matches the three-dimensional indicia 62 of the mold insert, or the sheet thereof, can include more than one layer such that the mold insert has differing thickness and such that the protrusions and/or indentations on the top of exterior of the sheet do not necessarily match those of the interior, or such that the exterior is flat while the interior has the protrusions and/or indentations.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A promotional device, comprising:
a) a container comprising a window portion that is at least translucent;
b) a moldable dough disposed in the container and being pliable;
c) a mold insert disposed in the container and having a protrusion, an indentation, or both, formed therein and forming a three-dimensional indicia indicative of or representing a business, a product, or both, and defining an interior negative mold;
d) the interior negative mold being embedded in the dough to form an exterior positive impression of the mold in the dough and thus a three-dimensional indicia indicative of or representing the business, product, or both, in the dough; and
e) the mold insert, the moldable dough, or both being visible through the window portion of the container.

2. The device in accordance with claim 1, wherein the mold insert further comprises:
a plastic sheet with the protrusion, the indentation, or both forming the interior negative mold on an interior side, and an exterior positive representation opposite of the interior negative mold on an opposite exterior side.

3. The device in accordance with claim 2, wherein an indentation on the interior side of the plastic sheet corresponds to a protrusion on the opposite exterior side; and wherein the plastic sheet comprises a single layer with a substantially constant thickness.

4. The device in accordance with claim 2, wherein the plastic sheet is at least translucent.

5. The device in accordance with claim 1, further comprising:
a release coating on the interior negative mold of the mold insert;
the release coating comprising a silicon oil.

6. The device in accordance with claim 1, wherein:
the container comprises a lid covering an opening in the container and with the lid and the container forming a substantially air-tight compartment;
the lid is at least translucent;
the mold insert is at least translucent; and
the exterior positive impression of the mold in the dough and the three-dimensional indicia indicative of or representing the business, product, or both, in the dough being visible through the mold insert and the lid.

7. The device in accordance with claim 1, wherein:
the container comprises a lid covering an opening in the container and with the lid and the container forming a substantially air-tight compartment;
the lid is at least translucent; and
the three-dimensional indicia indicative of or representing the business, product, or both, of the mold insert being visible through the lid.

8. The device in accordance with claim 1, further comprising:
a matching indicia carried by an exterior surface of the container and corresponding to the three-dimensional indicia.

9. The device in accordance with claim 1, wherein the dough is dryable in air to a rigid form.

10. A promotional device, comprising:
a) a container comprising an opening with a removable lid covering the opening in the container, and with the lid and the container forming a substantially air-tight compartment;
b) the lid being at least translucent;
c) a moldable dough disposed in the container and being pliable;
d) a mold insert disposed in the container and comprising a sheet having a protrusion, an indentation, or both, formed therein and forming a three-dimensional indicia indicative of or representing a business, a product, or both, and defining an interior negative mold on an interior side, and an exterior positive representation opposite of the interior negative mold on an opposite exterior side;
e) the plastic sheet comprises a single layer with a substantially constant thickness with an indentation on the interior side of the plastic sheet corresponding to a protrusion on the opposite exterior side;
f) the interior negative mold being embedded in the dough to form an exterior positive impression of the mold in the dough and thus a three-dimensional indicia indicative of or representing the business, product, or both, in the dough;
g) the sheet being at least translucent with the dough being visible therethrough; and
h) the exterior positive impression of the mold in the dough and the three-dimensional indicia indicative of or representing the business, product, or both, in the dough being visible through the mold insert and the lid.

11. The device in accordance with claim 10, further comprising:
a matching indicia carried by an exterior surface of the container and corresponding to the three-dimensional indicia.

12. The device in accordance with claim 10, further comprising:
a release coating on the interior negative mold of the mold insert, the release coating comprising a silicon oil.

13. A method for making a promotional device, comprising:
a) obtaining a plurality of precursors, each precursor including:
i) a container having a cavity therein and an opening therein to the cavity, and a lid removably coupled to the container and covering the cavity and closing the opening, the container and the lid forming a substantially air-tight compartment in the cavity; and
ii) a moldable dough disposed in the cavity of the container;
b) embossing or debossing a plurality of mold inserts, each mold insert including:
i) a protrusion, an indentation, or both, formed in the mold insert and forming a three-dimensional indicia indicative of or representing a business, a product, or both, and defining an interior negative mold thereof on an interior of the mold insert;
c) removing the lid from each of the plurality of precursors;
d) pressing each mold insert into the dough in each of the plurality of precursors to impart the interior negative mold of the mold insert into the dough to form an exterior positive impression of the mold in the dough and thus a three-dimensional indicia indicative of or representing the business, product, or both, in the dough; and
e) replacing the lid on each of the plurality of precursors.

14. The method in accordance with claim 13, further comprising:
leaving one of the mold inserts embedded in each of the plurality of precursors; and
replacing the lid on each of the plurality of precursors with the mold insert therein.

15. The method in accordance with claim 13, further comprising:
viewing the moldable dough through at least a portion of the lid, the mold insert, or both, with the at least a portion of the lid, the mold insert, or both being at least translucent.

16. The method in accordance with claim 13, wherein:
the lid is at least translucent;
the mold insert is at least translucent; and
the exterior positive impression of the mold in the dough and the three-dimensional indicia indicative of or representing the business, product, or both, in the dough being visible through the mold insert and the lid.

17. The method in accordance with claim 13, wherein:
the lid is at least translucent; and
the three-dimensional indicia indicative of or representing the business, product, or both, of the mold insert being visible through the lid.

18. The method in accordance with claim 13, wherein the dough is dryable in air to a rigid form.

19. The method in accordance with claim 13, further comprising:
a matching indicia carried by an exterior surface of the container or the lid and corresponding to the three-dimensional indicia.

20. The method in accordance with claim 13, further comprising:
a release coating applied to the interior negative mold of the mold insert.
